(19) United States
(12) Patent Application Publication
(10) Pub. No.: US 2010/0095858 A1
(43) Pub. Date: Apr. 22, 2010

(54) Golf Ball Marking Stencil and Method of Use

(75) Inventor: Rand J. Krikorian, Brentwood, TN (US)

Correspondence Address: EDELL, SHAPIRO & FINNAN, LLC, 1901 RESEARCH BOULEVARD, SUITE 400, ROCKVILLE, MD, 20850, US

(73) Assignee: Softspikes, LLC, Brentwood, TN (US)

(21) Appl. No.: 12/579,555

(22) Filed: Oct. 15, 2009

Related U.S. Application Data
(60) Provisional application No. 61/106,772, filed on Oct. 20, 2008.

(51) Int. Cl. B41F 17/30; B05C 17/08

(52) U.S. Cl. 101/35; 101/126

(57) ABSTRACT

A golf ball marking stencil includes two caps, resiliently biased toward one another, configured as spherical segments defining a cavity therebetween to securely retain a golf ball. Stencil slots for marking putt alignment path, putter face squareness and swing path lines are defined in the caps. Actuator tabs project from the caps and may be pinched together in opposition to a bias spring to force the caps open to expose the cavity. The spring force of the bias spring prevents movement of a retained golf ball relative to the caps. The cavity periphery is contoured to permit a marker pen to be engaged therein when the cavity does not contain a golf ball.

### CROSS REFERENCE TO RELATED APPLICATION

This application claims priority from U.S. Provisional Patent Application Ser. No. 61/106,772 entitled “Golf Ball Marking Stencil”, filed Oct. 20, 2008. The disclosure of this provisional patent application is incorporated herein by reference in its entirety.

### BACKGROUND OF THE INVENTION

1. Technical Field

The present invention pertains to an improved method and apparatus for marking golf balls.

2. Status of the Relevant Art

Proper putting alignment and stroke are two of the most difficult aspects of the game of golf, and accurate putting is one of the most important requisites for a good golf score. Most golfers have difficulty properly aligning a putter club head with a golf ball along an intended direction of ball travel and accurately stroking the putter club head through the ball along that direction. The ball striking surface must remain perpendicular to the direction of club head travel during the putting stroke, and the club head must be moved along the precise direction line of the putt to avoid hitting the ball off-line or imparting an undesired spin to the ball.

With this in mind, it is known in the prior art to provide at least one equatorial ball alignment marking line extending around the golf ball. The golf ball may then be positioned with the equatorial marking line lying within a vertical plane that is perpendicular to the putting green and that includes the direction in which the golf ball is to be struck. This arrangement facilitates proper initial alignment of a golf club putter face with a golf ball relative to a putt target line; i.e., by providing markings on the golf ball through which the golf ball is initially aligned with the target direction, resulting in accurate putter head alignment with both the golf ball and the target direction.

It is also known in the prior art to place markings on golf balls for a variety of purposes, chief among which is providing a true putting line to assist in lining up and stroking putts. For examples of prior patents disclosing ball marking methods and apparatus, see: U.S. Pat. Nos.: 6,595,128 (Parks); 6,216,587 (Foley); 6,004,223 (Newcomb); 5,662,530 (Sellar); 5,564,707 (Dinh); 4,974,511 (Hsi-Chou); 4,441,716 (Chen); 4,258,921 (Worst); 4,209,172 (Yamamoto); 3,753,565 (Baker); 3,420,529 (Goranson et al); 2,709,595 (De Vries); 1,842,944 (O'Brien); and 676,506 (Knight et al). The disclosures in these patents are incorporated herein by reference in their entireties. The principal drawbacks of the Chen and Hsi-Chou devices reside in their complexity in marking the ball and, in the case of Chen, using the marked ball. The Hsi-Chou device utilizes an electric motor-driven device for determining the center of gravity of a golf ball, so that the ball can be struck in the center plane to ensure true flight. Chen utilizes a complex grid pattern placed on the ball or on a ball holder which allows the golfer to gauge where the ball is being hit. Neither system addresses how to have the golfer find the true putting line on a green.

It is also known to provide templates or stencils to permit a golfer to draw equatorial lines on a golf ball. Typical of prior devices of this type are disclosed in the Parks and Foley patents. Foley and Parks attempt to provide equatorial lines (i.e., along great circles) on the golf ball surface using a resilient, partially spherical ball receptacle having cut-out or stencil portions that can be used to guide a pencil or marker, or the like, to provide a linear marking along the surface of the received ball. The interior surface of the receptacle is contoured such that the ball resides with a portion of a great circle of the ball aligned with the cut-out linear region, whereby the marked line lies along a portion of that great circle. One major problem with this type of device is that the resilient material of the receptacles must be stretched considerably during insertion and removal of the ball, thereby leaving the receptacle vulnerable to rupture after several uses.

It is an object of the invention to provide a simple and reliable apparatus and method for applying guide lines or markings on golf balls to assist a golfer in properly aligning a golf club head with the marked ball to enhance stroke accuracy.

It is another object of the invention to provide a golf ball marking unit that permits reliable and simple marking of putting path alignment lines on both sides of a golf ball.

Another object of the invention is to provide a golf ball marking unit that permits reliable and simple marking of putter face squareness lines on a golf ball to assist a golfer to maintain the putter face square with the ball and putting path through putting stroke impact.

Yet another object of the invention is to provide a golf ball marking unit that permits reliable and simple marking of lines to help promote a proper swing path for golf swings.

The above stated objects are achieved by the present invention individually and in combination and are not to be construed so as to limit the scope of the invention.

### SUMMARY OF THE INVENTION

In accordance with the present invention a golf ball marking unit comprises two stencil members, each comprising a respective cap having an interior surface in the form of a segment of a hollow sphere. The caps are resiliently pivotally hinged together at a section of their peripheries by a torsion spring and positioned with their concave interior surfaces in mutually facing relation. The radius of curvature of the interior surface of each cap is substantially equal to the radius of a standard golf ball which most typically is approximately 0.84 inches. The spring serves to pivotally bias the two caps toward one another in a closed position in which their interiorly facing concave surfaces define a volume between them which is smaller than the volume of a golf ball. Respective aligned tabs extend outwardly from the hinge region of each stencil member and are finger-actuable (i.e., with pinching force applied between a person's thumb and forefinger to respective tabs) to pivotally spread the caps apart and thereby open the space between them to receive a golf ball. Release of the tabs permits the spring bias to firmly close the caps about the inserted ball. The concave interior surfaces of the caps are arcuately contoured to match the outer contour of the retained golf ball in close proximity. The trapped golf ball is gripped with sufficient force to prevent the ball from inadvertently spinning or otherwise moving relative to the stencil member caps. Respective linearly arcuate stencil slots or apertures are defined through the caps and extend circumferentially in a common plane corresponding to that of an equator or great circle of the retained golf ball. In the preferred embodiment the slot in one of the spherical caps subtends an angle of approximately 150° and the slot in the other spherical cap subtends an angle of approximately 110°. It is to be understood that these angles are for a particular preferred embodiment and are not limiting on the scope of the invention. Other stencil slots may be provided in the caps to permit markings on a golf ball that assist golfers in guiding strokes other than putting.

A marker pen may be used to draw line segments through the stencil slots on and along the corresponding great circle of the trapped golf ball. Also as part of the preferred embodiment, aligned arcuate cutout sections are defined in the circumferential edge of one or both of the stencil members. These cut out sections are configured to receive a marker pen, or the like, which may be packaged and sold with the marking unit as a single product.

The stencil assembly permits a golf ball to be marked with two long line segments residing in a common equatorial circle on the periphery of a golf ball and covering approximately 260° of that circle. When the ball rolls after being struck by a putter, the two lines should remain in a vertical plane if the putting stroke was accurately directed, or wobble out of verticality if the stroke was incorrectly directed. In any case, the golfer will receive immediate visual feedback regarding the correctness of the putting stroke. In addition, the marked lines permit the golfer to more easily align the putter head prior to the stroke.

The above and still further features and advantages of the present invention will become apparent upon consideration of the following definitions, descriptions and descriptive figures of specific embodiments thereof wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

FIG. 1A is a top rear view in perspective of a preferred embodiment of a golf ball marking unit constructed in accordance with the principles of the present invention shown in its ball retaining position with a retained golf ball.

FIG. 1B is a top view in plan of the unit of FIG. 1A.

FIG. 1C is a side view in elevation of the embodiment of FIG. 1A.

FIG. 1D is a front view in elevation of the embodiment of FIG. 1A.

FIG. 1E is a top front view in perspective of the unit of FIG. 1A

FIG. 1F is a top front view in perspective of the unit of FIG. 1A shown in its closed position without a retained golf ball but with a retained marker pen.

FIG. 1G is a bottom view in plan of the embodiment of FIG. 1A.

FIG. 2A is a top view in perspective of the top stencil member of the marking unit of FIG. 1A.

FIG. 2B is a top view in plan of the top stencil member of the marking unit of FIG. 1A.

FIG. 2C is a side view in elevation of the top stencil member of the marking unit of FIG. 1A.

FIG. 2D is a front view on elevation of the top stencil member of the marking unit of FIG. 1A.

FIG. 3A is a top view in perspective of the bottom stencil member of the marking unit of FIG. 1A.

FIG. 3B is a top view in plan of the bottom stencil member of the marking unit of FIG. 1A.

FIG. 3C is a side view in elevation of the bottom stencil member of the marking unit of FIG. 1A.

FIG. 3D is a front view in elevation of the bottom stencil member of the marking unit of FIG. 1A.

FIG. 4A is a side view in elevation showing the marking unit of the embodiment of FIG. 1A in it open position and a golf ball positioned in the bottom stencil member of the unit.

FIG. 4B is a side view in elevation showing the marking unit of the embodiment of FIG. 1A in its fully closed position.

FIG. 4C is a partial side view in elevation of the lower stencil unit in FIG. 4B.

FIG. 4D is a side view in elevation showing the marking unit of the embodiment of FIG. 1A in its fully closed position, similar to FIG. 4B but showing the retained marker pen.

FIG. 4E is a front view in elevation of the embodiment of FIG. 4D.

FIG. 4F is a top view in plan of the embodiment of FIG. 4D.

### DETAILED DESCRIPTION OF PREFERRED EMBODIMENTS

The following detailed description of the preferred embodiment makes reference to all of the accompanying drawings wherein like reference numerals refer to like components in the several figures. The dimensions shown in the drawings are by way of example of one operative embodiment only and should not be construed as limiting on the scope of the invention.

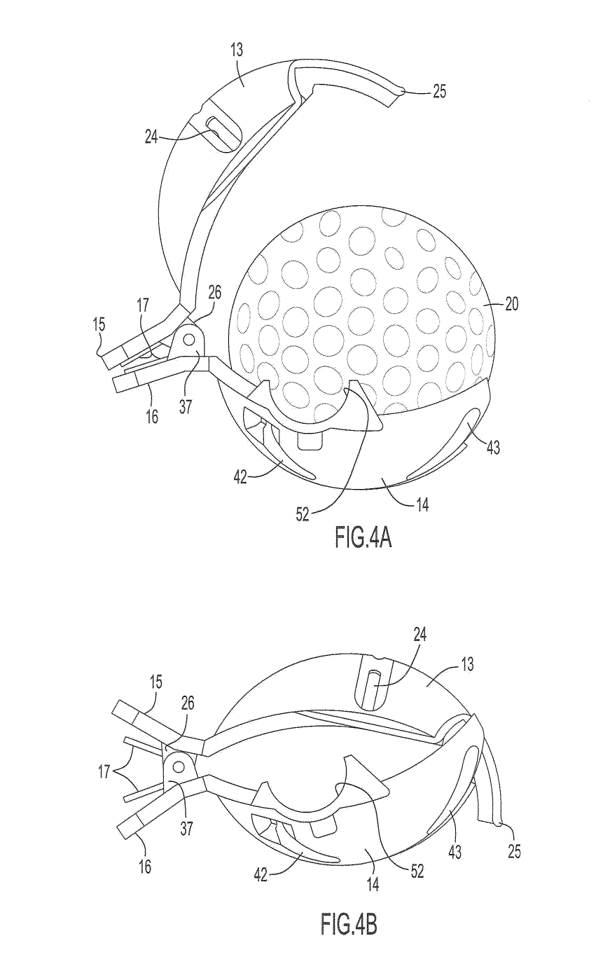

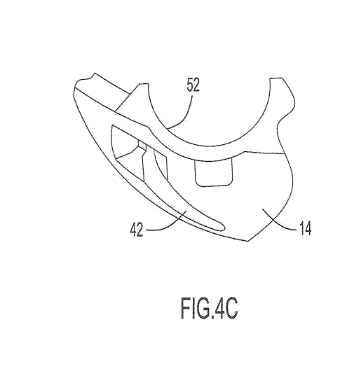

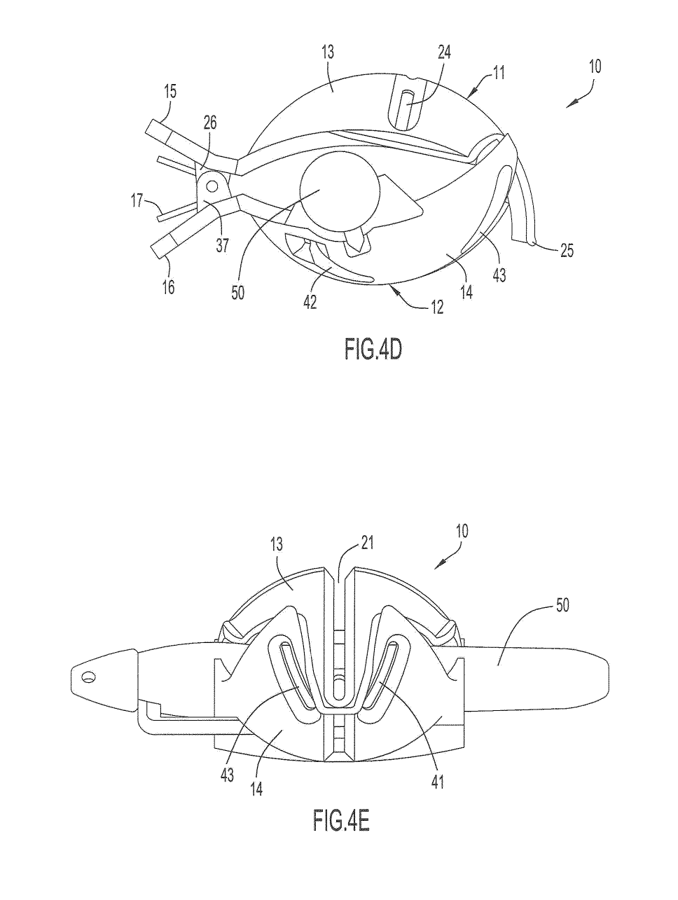

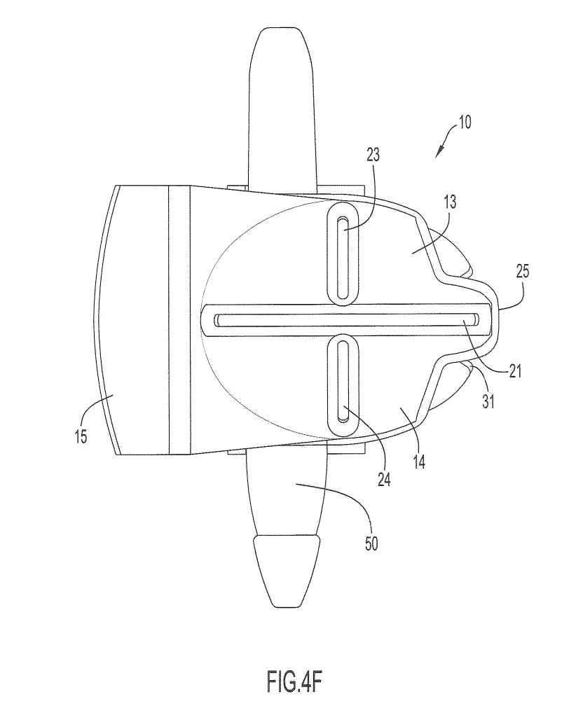

Referring to the drawings in greater detail, a golf ball marking unit 10 comprises a top stencil member 11 and bottom stencil member 12, each including a respective cap 13, 14 having an interior surface in the form of a segment of a hollow sphere. Stencil members 11, 12 are separate rigid (i.e., not significantly flexible or resilient) members made from a suitable molded polymer material such as, by way of example, acrylonitrile butadiene styrene (ABS). The thickness of the stencil members in the preferred embodiment, again by way of example only, is approximately 2.5 mm. Stencil members 11, 12 are pivotally joined at a rearward section of their peripheries by a torsion spring 17 and are positioned with the concave interior surfaces of caps 13, 14 in mutually facing relation. Spring 17, in addition to joining the two stencil members 11, 12, serves to resiliently bias the caps 13, 14 toward one another to a fully closed position in which their interiorly facing concave surfaces define a volume between them which is smaller than the volume of a standard golf ball 20, as best illustrated in FIGS. 4B, 4D and 4E. Respective aligned tabs 15, 16 face one another and extend outwardly from the hinge region of each stencil member 11, 12. Tabs 15, 16 and are finger-actuable (i.e., with a pinching force applied between the thumb and forefinger to respective tabs) to pivotally force the tabs toward one another while pivotally spreading the caps 13, 14 apart to open the space between them to receive a golf ball 20. Release of the tabs permits the spring bias to firmly close the caps 13, 14 about the inserted ball.

The mutually facing concave interior surfaces of caps 13, 14 are arcuately contoured to match a portion of the outer contour of the retained golf ball 20 in close proximity. Golf balls typically have an outer diameter on the order of 1.68 inches, and the curvature of the interior surfaces of caps 13, 14 is appropriately defined. The physical parameters of torsion spring 17 are chosen such that the trapped golf ball is gripped by caps 13, 14 with sufficient force to prevent the ball from inadvertently moving within the closed stencil members 11, 12. Putt path alignment stencil slots 21, 22 or similar apertures are defined through respective caps 13, 14 and extend circumferentially in a common plane corresponding to that of an equator or great circle of the caps and the retained golf ball 20. These slots, as described below, permit a golfer to mark putt path alignment line segments on golf ball 20. In the preferred embodiment the putt path alignment slot 21 in cap 13 subtends a circumferential angle of approximately 150°, and putt path alignment slot 22 in cap 14 subtends an angle of approximately 110°, thereby permitting two spaced coplanar line segments covering a total of 260° to be marked on a golf ball. Slots 21, 22 are circumferentially spaced by 40° at the rearward end (i.e., closest to the pivot axis of spring 17) of the unit and by 60° at the forward end of the unit. The resulting putt path alignment lines cover a sufficient part of the circumference along a great circle of golf ball 20 to appear substantially continuous to the golfer's eye as the ball is rolling after being struck by a putter. It is to be understood that these slot circumferential lengths (i.e., angles) are for stated for a particular preferred embodiment and are not limiting on the scope of the invention. In other words, other stencil slot configurations and locations may be defined through the caps to permit markings on golf ball that assist golfers in guiding strokes other than putting. Moreover, instead of being provided as two putt path alignment slots 21, 22, each of those slots can be segmented into two, three, or more slots spaced along the described great circle.

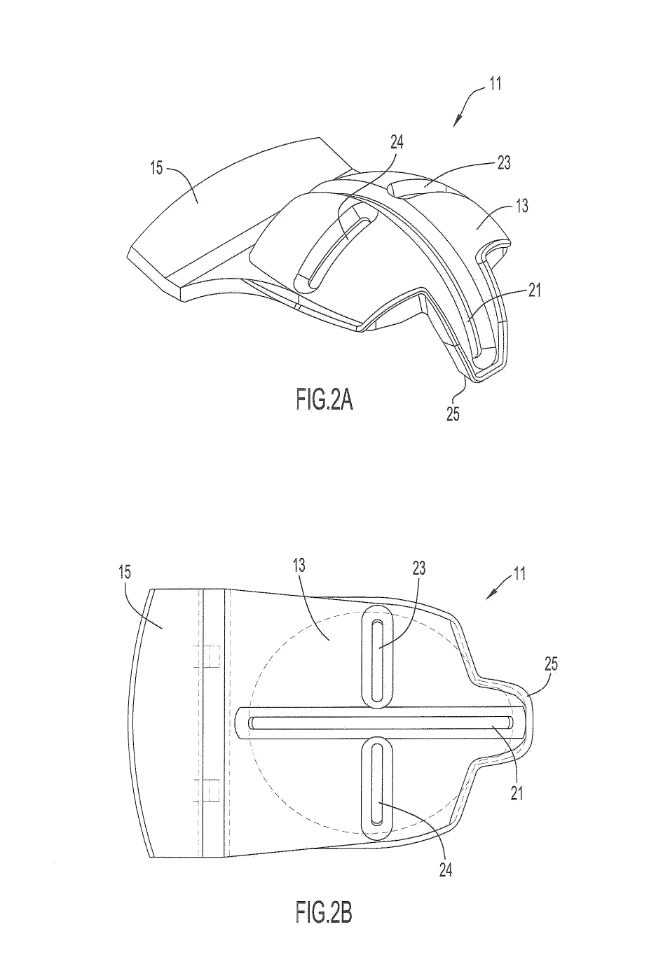

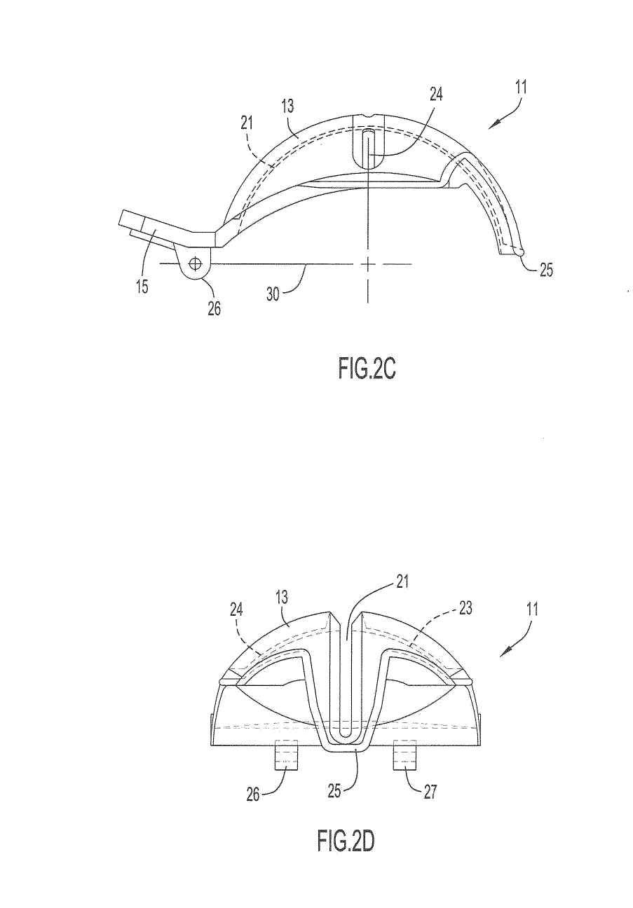

As best illustrated in FIGS. 2A through 2D, top stencil member 11 includes a narrowed forward tip 25 extending circumferentially forward from cap 13 to a location substantially diametrically opposite the hinge region and along the same radius of curvature as cap 13. Tip 25 tapers forwardly and is provided to contain the extended forward portion of stencil slot 21 without including unnecessary excess material as part of stencil member 11. Otherwise stated, rather than completely enclosing a retained golf ball, a relatively small spherical cap portion 13 is all that is required to cooperate with cap portion 14 to retain a golf ball in place under the effect of the bias spring 17. However, a cap portion of minimum size to necessarily retain a golf ball is not necessarily long enough to incorporate a stencil slot of sufficient length for the desired ball marking. Accordingly, tip 25 is provided with limited width to structurally contain and support extended slot 21. Thus, whereas the wider golf ball gripping segment of cap 13 subtends a back to front angle about the retained golf ball 20 on the order of 130°, tip 25 extends that angle to approximately 175° in order to extend slot 21. As best illustrated in FIG. 2C relative to the center point of a retained golf ball, the combined structure of cap 13 and tip 25 subtends a total angle of very slightly less than 180° about the ball from back to front of the unit. Tip 25 is preferably symmetrical about the plane defined by slots 21 and 22.

Referring still to FIGS. 2A through 2D, tab 15 extends rearward and upward from cap 13 at a small angle on the order of between 5° and 15° relative to an imaginary plane 30 (FIG. 2C) extending perpendicular to the plane defined by slots 21, 22 and through the center of retained golf ball 20. The top surface of tab 15 is flat. A pair of flanges 26, 27 depend from the lower surface of tab 15 and are transversely equally spaced on opposite sides of a centerline residing in plane 30 containing the golf ball center and oriented perpendicular to the plane defined by slots 21, 22. Each flange has a respective aperture defined therethrough, the centers of the apertures defining a transversely extending pivot line residing in plane 30.

Top stencil member 11 may optionally include, in addition to stencil slot 21, two additional stencil slots 23, 24 defined therethough. Stencil slots 23, 24 are putter face squareness slots that extend from opposite sides of slot 21 and reside in an equatorial circle in a plane perpendicular to the plane of slots 21, 22 and to plane 30. Slots 23, 24 are between 40° and 60° in circumferential length and permit lines to be marked on the golf ball in a plane parallel to the putter face at the time of impact with the ball, thereby facilitating putter face alignment prior to a putting stroke. The side walls of slots 21, 22, 23 and 24 and other stencil slots described herein are chamfered (i.e., converging inward toward the retained golf ball) to provide guide surfaces for the conical tip of a marker pen when the tip is inserted through the slot during a ball marking operation. In the preferred embodiment the chamfer angle between opposite sides of the slot is on the order of 80° throughout most of the slot length and decreases gradually at the slot ends to approximately 40° to help guide the marker pen tip out of the slot at the end of a marking stroke. In a preferred embodiment the width of the slots throughout the major portions of their lengths tapers, as a result of the chamfer, from approximately 0.2 inches to approximately 0.07 inches.

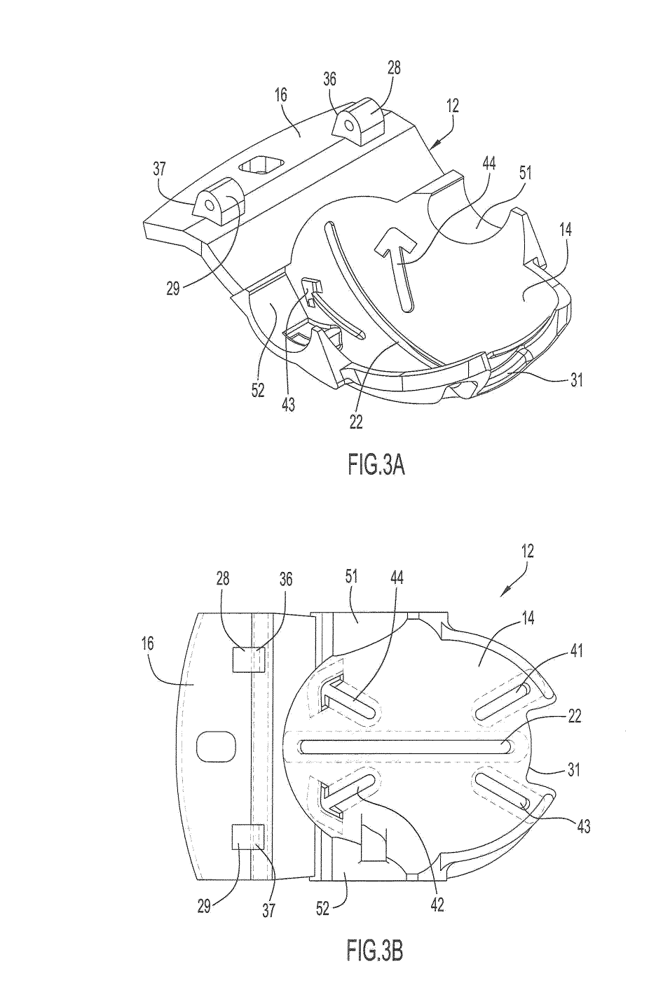

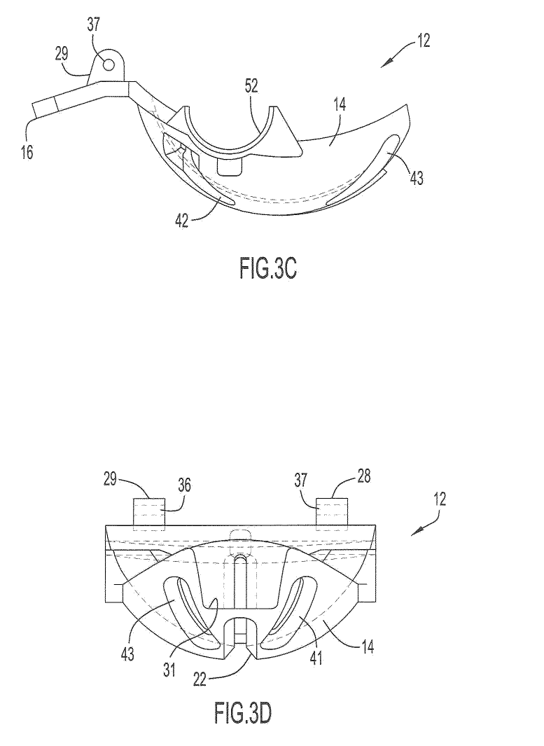

Referring to FIGS. 3A through 3D, cap 14 of stencil member 12 includes a cut-out section 31 at its forward end positioned to be symmetrical about the plane defined by slots 21, 22 and contoured to receive the tip 25 of stencil member 11 when the unit 10 is in its fully closed position without a golf ball positioned between caps 13 and 14. This closed position is best illustrated in FIGS. 4B, 4D and 4E. Tab 16 extends rearward and downward from cap portion 14 at a small angle on the order of 5° to 15° relative to plane 30 (FIG. 2C). The bottom surface of tab 16 is flat. A pair of flanges 28, 29 project upward from the top surface of tab 16 and are transversely equally spaced on opposite sides of a line residing in plane 30 containing the golf ball center and oriented perpendicular to the plane defined by slots 21, 22. Each flange 28, 29 has a respective aperture 36, 37 defined therethrough, the centers of the apertures residing on the transversely extending pivot line defined by the apertures in flanges 26, 27 of stencil member 11 and residing in plane 30. The spacing between flanges 28, 29 is such that the facing transversely inner surfaces of these flanges slidably abut the transversely outer surfaces of flanges 26, 27, respectively, of stencil member 11.

Bottom stencil member 12, in addition to stencil slot 22, preferably has four separate swing path stencil slots 41, 42, 43 and 44 defined therein, each extending at an angle of approximately 30° relative to slot 22. Slots 41 and 43 are symmetrically located at transversely opposite sides of the forward portion of slot 22 and diverge forwardly. Slots 42 and 44 are symmetrically located at transversely opposite sides of the rearward portion of slot 22 and diverge rearwardly. Slots 41 and 42 are co-linear and slots 43 and 44 are co-linear. Each co-linear pair of swing path stencil slots permits a respective pair of swing path lines to be marked on a ball retained between caps 13, 14. To this end, the rearward terminus of slots 42 and 44 are provided with arrowhead cut outs to designate swing path direction on the marked golf ball.

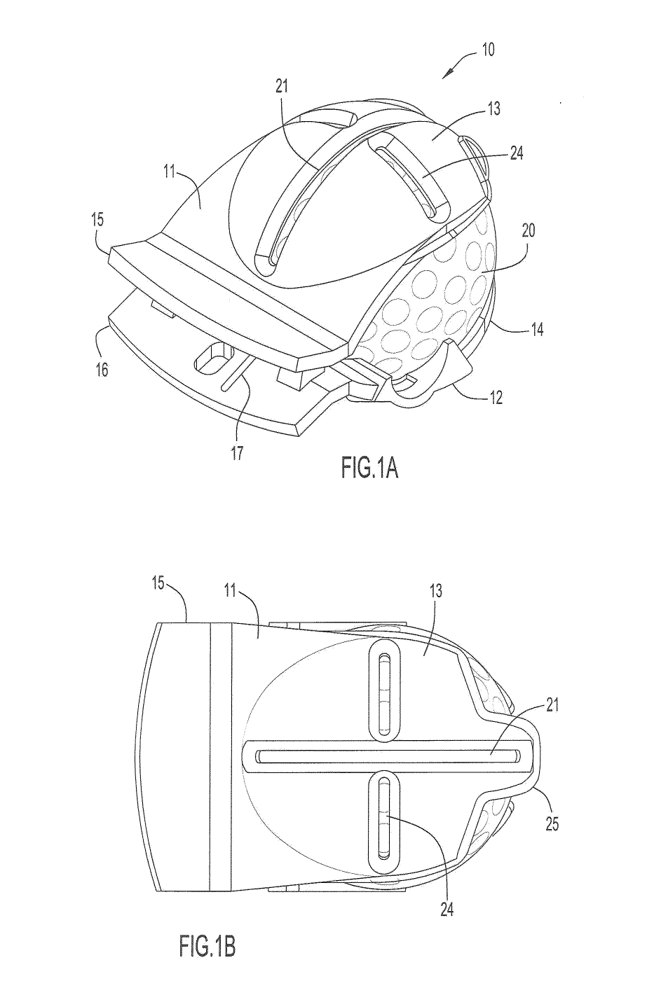

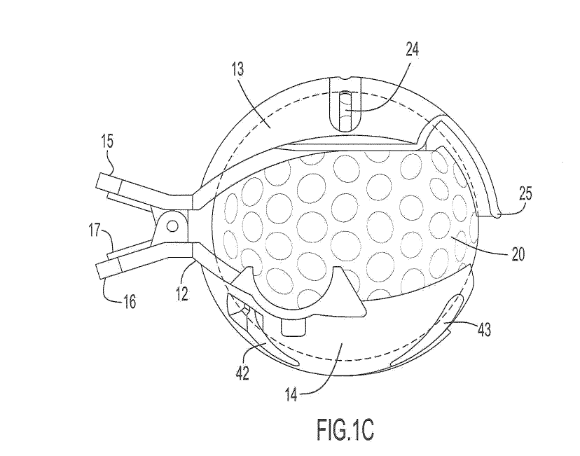

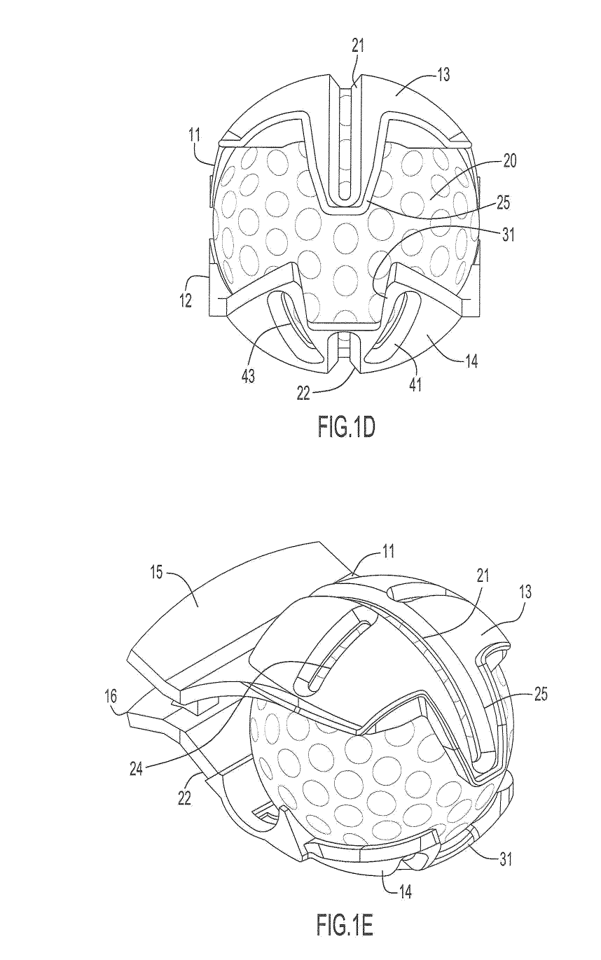

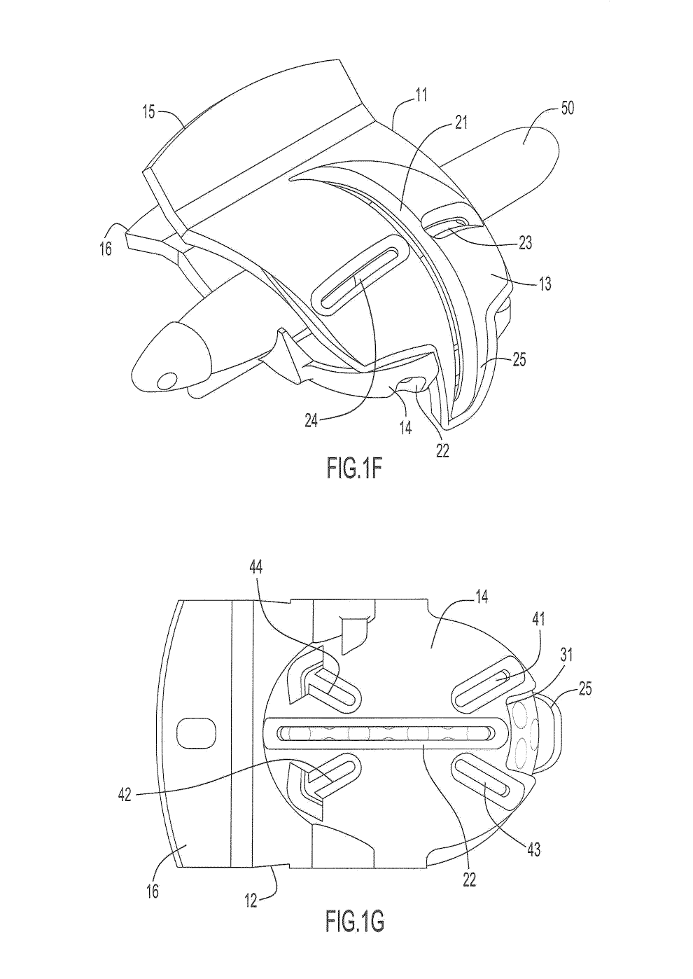

Torsion spring 17 has its coil diameter configured to permit the spring to reside in the four co-linearly aligned apertures defined in respective flanges 26, 27, 28 and 29. The ends of the spring extend through flanges 28, 29 and are bent such that each urges a respective tab 15, 17 away from the other tab, thereby biasing the unit caps 13, 14 toward their closed position. The unit may be forced to its open position as illustrated in FIG. 4A by finger pressure (thumb and forefinger) urging the tabs toward one another against the spring bias. The distal ends of the flanges 26, 27, 28, 29 are arcuately contoured to facilitate smooth rotation thereof along the surface of the opposite tab members as the stencil members are pivoted open/closed. Golf ball 20 may be placed in the open unit, after which the finger pressure is removed to permit caps 13, 14 to close upon and grip the ball as illustrated in FIGS. 1A, 1B, 1C, 1D and 1E. A marker pen may then be used to mark the golf ball surface as desired through the various stencil slots 21, 22, 23, 24, 41, 42, 43, 44. To facilitate use of the device, the stencil slots may be marked with lettering to indicate the function of the lines that are marked through those slots.

As illustrated in FIGS. 1F, 4D, 4E and 4F, the marking unit 10 may be supplied with a marker pen 50 sold in a common package and gripped between the fully closed stencil members 11, 12. To accommodate this mounting arrangement the bottom stencil member is provided with a pair of transversely aligned, arcuate, and generally semi-circular recesses 51, 52 defined in its opposite transverse edges and contoured to receive a similarly arcuate outer surface of the marker pen. The marker pen when thusly positioned extends transversely across the bottom cap portion 14 and is held in place in the recesses by opposed portions of the edges of cap portion 13 that contact marker 50 and urge it into the recesses by the action of torsion spring 17.

The marking unit 10 and marker 50 may be packaged on a display card as part of a point of purchase display package for the unit. Depending on the nature of the card, the unit can be positioned in various manners for display. In any case, the depth or thickness of the packaged unit is smaller than the diameter of a golf ball, thereby minimizing display shelf and display space requirements without sacrificing display visibility of the item.

The invention as described herein uses two caps, resiliently biased toward one another, and having interior surfaces in the shape of spherical segments that define a cavity therebetween to securely retain a golf ball so that two sides of the ball can be easily and accurately marked with golf stroke guide lines applied through slots defined through the caps. The cavity periphery is contoured to permit a marker pen to be engaged partially therein when the cavity does not contain a golf ball.

As briefly noted hereinabove, the marking unit may have printed indicia thereon describing the function of the various stencil slots 21-24 and 41-44. For example, characters spelling “Putting Line” may be printed on the exposed surface of cap 13 adjacent slot 21 and/or on the exposed surface of cap 14 adjacent slot 22. Likewise, characters spelling “Putter Face” may be printed on the exposed surface of cap 13 adjacent slots 23 and 24. Characters spelling “Swing Path” may be printed on the exposed surface of cap 14 adjacent swing path slots 41-44.

In a preferred embodiment, in addition to the exemplary dimensions described hereinabove, the marking unit may have the following exemplary dimensions which are provided herein solely as an example for a particular unit and are not to be construed as limiting the scope of the invention: length of unit from distal end of tabs 15, 16 to forward end of tip 25: 2.49 inches; width of unit across tab 15 (or 16): 1.69 inches; height of unit in fully closed position (between apices of caps): 1.3 inches; radius of curvature of recesses 51, 52: 0.43 inches.

As seen in the accompanying drawings, the marking unit is configured so that the caps 13, 14 do not completely cover or enclose golf ball 20 when the caps are closed about the retained ball. Such complete covering may, of course be provided in other embodiments of the invention but it would require more polymer material, thereby increasing the manufacturing cost, and would increase the size of marking unit 10, particularly in its fully closed position, thereby increasing the size of the point of purchase packaging. These factors significantly outweigh the small increase in the length of slots 21, 22 that would be made possible in a unit providing for complete covering of the retained golf ball. The important point here is that the coverage of the retained ball by caps 13, 14, including tip 25, should be sufficient to include the desired stencil slots 21-24 and 41-44, and to hold the retained ball motionless under the force of spring 17 during a marking procedure. Viewed analogously, stencil member 11 and 12 each contact and cover less than half of the surface of the retained golf ball, typically on the order of twenty to thirty-five percent of that surface. This provides for a wide latitude of permissible ball surface coverage, depending on the spring force, and it has been found that good results are obtained with total coverage of between thirty and eighty percent of the ball surface, including the area of the stencil slots as part of the coverage, with about fifty percent coverage being very workable.

Several variations from the details of the disclosed embodiment will be suggested and become apparent to persons of ordinary skill in the art. For example, the spring bias need not be provided by a separate torsion spring but may instead comprise a living hinge joining the two stencil members as an integral unit. Likewise, the cap segments are shown in the drawings to be solid throughout (except, of course, for the marking slots); however, it will be understood that, to conserve material cost the caps can be apertured at various locations. Further, the marking slots 21-24 and 41-44 need not be continuous but instead may be interrupted line segments or similar linearly aligned apertures that permit the marking indicia on the retained ball to be dashed, dotted or otherwise segmented rather than continuous lines. These and other variations from the disclosed embodiment are intended to fall within the scope of the present invention.

The marking tool of the present invention has the following unique and advantageous features:
(a) Slots 21, 22 permit marking of putting path alignment lines on both sides of a golf ball.
(b) The putter face squareness line slots 23, 24 permit marking of lines for keeping the putter face square through impact.
(c) The swing path reminder line slots 41-44 permit marking of lines to help promote a proper swing path.
(d) The unit is designed to securely hold a Sharpie Mini marker included in the unit as sold.

It is to be understood that terms such as “bottom”, “front”, “rear”, “side”, “width”, “upper”, “lower”, “interior”, “exterior”, “inner”, “outer” and the like as used herein, merely describe points of reference and do not limit the present invention to any particular orientation or configuration.

While the invention has been described in detail and with reference to a specific embodiment thereof, it will be apparent to one skilled in the art that various changes and modifications can be made therein without departing from the spirit and scope thereof. For this reason it is submitted that the invention should be measured by the scope of the attached claims and their equivalents rather than by the specific details of the preferred embodiment disclosed herein.

I claim:

1. A stencil apparatus for use in marking indicia on a golf ball comprising:
a first stencil member having first cap with an interior surface in the form of a segment of a sphere having a radius of curvature that is substantially the same as the radius of curvature of a golf ball;
a second stencil member having a second cap with an interior surface in the form of a segment of a sphere having a radius of curvature that is substantially the same as the radius of curvature of a golf ball;
bias means disposed at a rearward portion of said apparatus for resiliently pivotally securing said first and second stencil members to one another with said interior cap surfaces in generally facing relation, said bias means resiliently urging said interior surfaces toward one another with sufficient force to retain a golf ball in fixed position between said interior surfaces;
wherein at least said first cap has at least a first stencil aperture defined therethrough to permit indicia to be applied by a marker pen or the like through the first stencil aperture to the surface of a retained golf ball.

2. The apparatus of claim 1 wherein said first stencil aperture is a first elongated slot defined through the first cap to permit said indicia to be applied to the retained golf ball as a first putt alignment line.

3. The apparatus of claim 2 wherein said second cap has at least a second stencil aperture defined therethrough to permit indicia to be applied by a marker pen or the like through the second stencil aperture to the surface of the retained golf ball.

4. The apparatus of claim 3 wherein said second stencil aperture is a second elongated slot defined therethrough to permit said indicia to be applied to the retained golf ball as a second putt alignment line coplanar with said first putt alignment line.

5. The apparatus of claim 4 wherein said at least one of said first and second caps has squareness line apertures defined therethrough in a linear array perpendicular to said first elongated slot to permit a squareness line to be applied to the retained golf ball.

6. The apparatus of claim 5 wherein at least one of said caps has swing path line apertures defined therethrough in a linear array intersecting at least one of said first and second elongated slots.

7. The apparatus of claim 1 wherein said second cap has at least a second stencil aperture defined therethrough to permit indicia to be applied by a marker pen or the like through the second stencil aperture to the surface of the retained golf ball.

8. The apparatus of claim 7 wherein said first stencil member includes a narrow tip extending forwardly from said first cap and having an interior surface configured as an extension of the interior surface of said first cap with the same radius of curvature, and wherein said second stencil member has a cutaway section in its forward edge positioned and configured to receive said tip from said first stencil member when said first and second stencil member are biased together a fully closed position with no golf ball between them.

9. The apparatus of claim 8 wherein at least one of said first and second stencil members has first and second transversely aligned arcuate recesses defined in edges thereof to receive a marker pen extending between the recesses.

10. The apparatus of claim 7 wherein said bias mean includes first and second actuation tabs extending rearwardly in a diverging orientation from said first and second stencil members, respectively, and a torsion spring centered about a pivot axis with its ends contacting respective tabs to pivotally urge the tabs apart about the pivot axis while urging the first and second caps toward one another.

11. A golf ball marking stencil apparatus comprising:
first and second caps resiliently biased toward one another and configured as spherical segments defining a cavity therebetween to receive and retain a golf ball;
stencil slots defined in the caps for marking putt alignment path indicia on a golf ball retained in the cavity;
a bias spring for urging said caps to a closed position;
actuator tabs projecting from the caps and configured to be pinched together in opposition to the bias spring to force the caps to an open position to expose the cavity for receiving the golf ball;
wherein the cavity periphery is contoured to permit a marker pen to be received and engaged therein when the cavity does not contain a golf ball.

12. The apparatus of claim 11 wherein said stencil slots include:
a first elongated slot defined through the first cap to permit said indicia to be applied to the retained golf ball as a first putt alignment line; and
a second elongated slot defined through the second cap to permit said indicia to be applied to the retained golf ball as a second putt alignment line coplanar with said first putt alignment line.

13. The apparatus of claim 11 further comprising engagement means including said bias spring for pivotally joining said first and second caps at a rearward location, wherein said bias spring is configured and located to pivotally urge said caps toward a closed position in which at least one dimension of the apparatus is smaller than the diameter of the golf ball.

14. The apparatus of claim 13:
wherein each of said first and second caps has an interior surface with a radius curvature substantially the same as the radius of a golf ball; and
wherein, with a golf ball retained between the interior surfaces of the caps, the force of said bias spring urges said interior surfaces against the golf ball surface to prevent movement of the golf ball relative to said caps.

15. The apparatus of claim 13 wherein said bias spring has sufficient spring force to prevent movement of the retained golf ball relative to said caps.

16. A method of marketing a marking stencil for marking golf balls with putt alignment indicia comprising the step of packaging a stencil unit and a marker pen in a common package for retail sale with the marker pen secured between two stencil members resiliently biased together to grip the marker unit.
